(19) United States
(12) Patent Application Publication
(10) Pub. No.: US 2022/0125010 A1
(43) Pub. Date: Apr. 28, 2022

(54) Pet Drinking Bowl

(71) Applicants: Brian Sarinova, Los Gatos, CA (US); Bryce Berryessa, Santa Cruz, CA (US)

(72) Inventors: Brian Sarinova, Los Gatos, CA (US); Bryce Berryessa, Santa Cruz, CA (US)

(21) Appl. No.: 17/081,083

(22) Filed: Oct. 27, 2020

(51) Int. Cl. A01K 7/02; E03D 9/00

(52) U.S. Cl. CPC A01K 7/025; E03D 1/26; E03D 9/00

(57) ABSTRACT

A pet drinking bowl system has a toilet tank lid with sidewalls and a top wall with a molded-in bowl, an overflow opening in the bowl, the overflow opening communicating with an overflow passage through the top wall flowing excess water from the bowl to the toilet tank, and a fill passage through the top connecting by a flexible tube under the lid to a fill mechanism in the toilet tank, and above the lid to a spout shaped to provide a stream of water in an arc above the bowl into the bowl. During a flush and fill cycle water from the fill mechanism is supplied to the spout, which provides water in a stream to the bowl, and excess water in the bowl drains back to the toilet tank through the overflow opening.

### BACKGROUND OF THE INVENTION

### 1. Field of the Invention

The present invention is in the technical area of pet maintenance apparatus and pertains more particularly to a pet drinking bowl implemented in a toilet tank lid.

### 2. Description of Related Art

It is well known that here are many diverse drinking bowls and systems commercially available for use by pets, such as, for example, domestic cats. One example is U.S. Pat. No. 5,522,096 to inventor Brown. This apparatus and system is not a drinking bowl, but a finger washing bowl that is described as being attachable to an existing toilet tank without major modifications. In FIG. 3 of Brown the bowl is integrated with a planar component that is attached to the top of a toilet tank in place of a conventional tank top.

Another document in the prior art is US application 2007/0226886 to inventor Rucker et al. This teaching is for a flower vase with an upper rim that is supported through a hole in a toilet tank lid such that the vase extends down into the water in the tank.

The Brown teaching is closer to the instant invention than the Rucker teaching but does not have many features that are taught in the present invention in descriptions below. What is clearly needed in the art is a drinking bowl for pets that is integrated into a toilet tank top and connected to existing functions of a toilet tank.

### BRIEF SUMMARY OF THE INVENTION

In one embodiment of the invention a pet drinking bowl system is provided, comprising a toilet tank lid having sidewalls implemented to fit over a top rim of a toilet tank, and a horizontal top wall with a molded-in bowl, an overflow opening implemented at an upper rim of the molded-in bowl, the overflow opening communicating with an overflow passage through the top wall, such that above a depth from a bottom of the bowl to the overflow opening, water flows from the bowl to the toilet tank, and a fill passage through the top wall having first fitting under the top wall connecting the fill passage by a flexible tube to a fill mechanism in the toilet tank, and a fitting above the top wall connecting the fill passage to a spout shaped to provide a stream of water in an arc above the bowl into the bowl. During a flush and fill cycle water from the fill mechanism is supplied to the spout, which provides water in a stream to the bowl, and excess water in the bowl drains back to the toilet tank through the overflow opening.

In one embodiment the system further comprises a drain opening at a lowermost extremity of the bowl, and a stopper sized to fit the drain opening, such that the drain opening may be plugged to hold water in the bowl or unplugged to drain water from the bowl. Also, in one embodiment the stopper further comprises a tether connecting the stopper to a point away from the drain opening. In one embodiment the system further comprises a first flow control valve implemented in the flexible tube from the fill mechanism, enabling a user to adjust flow of water through the flexible tube. And in one embodiment the system further comprises a second flow control valve implemented above the top wall below the spout enabling a user to adjust flow of water to the spout above the lid.

In another aspect of the invention a pet drinking bowl system is provided, comprising a toilet tank lid having sidewalls implemented to fit over a top rim of a toilet tank, and a horizontal top wall with a molded-in bowl, an overflow opening implemented at an upper rim of the molded-in bowl, the overflow opening communicating with an overflow passage through the top wall, such that above a depth from a bottom of the bowl to the overflow opening, water flows from the bowl to the toilet tank, a drain opening at a lowermost extremity of the bowl, and a stopper sized to fit the drain opening, such that the drain opening may be plugged to hold water in the bowl or unplugged to drain water from the bowl, and a rigid tube passing upward through a hole in the stopper, with the stopper in place plugging the drain opening, extending to a height above the rim of the bowl, the rigid tube connected below the bowl to a flexible tube to a fill mechanism in the toilet tank. During a flush and fill cycle water from the fill mechanism is supplied to the rigid tube, which provides water in a stream to the bowl, and excess water in the bowl drains back to the toilet tank through the overflow opening.

In one embodiment the system further comprises a first flow control valve implemented in the flexible tube from the fill mechanism, enabling a user to adjust flow of water through the flexible tube. Also, in one embodiment the system further comprises a second flow control valve implemented in the rigid tube at an uppermost end, enabling a user to adjust flow of water in the stream to the bowl. In one embodiment the spout is implemented in a flexible material such that the spout deforms rather than breaks.

In one embodiment the flexible tube connecting to the fill mechanism has a tee with a tube from an outlet of the tee providing water to the toilet bowl during a flush and fill cycle.

### BRIEF DESCRIPTION OF THE SEVERAL VIEWS OF THE DRAWINGS

FIG. 1 is a perspective view of a pet drinking bowl integrated with a toilet tank lid in one embodiment of the present invention.

FIG. 2A is a cross section of the apparatus of FIG. 1 taken along the section line 2-2 of FIG. 1.

FIG. 2B illustrates a section having somewhat different features than that of FIG. 2A.

FIG. 3 is a lateral cross section of the toilet tank lid and bowl of FIG. 1 taken along section line 3-3 in FIG. 1.

### DETAILED DESCRIPTION OF THE INVENTION

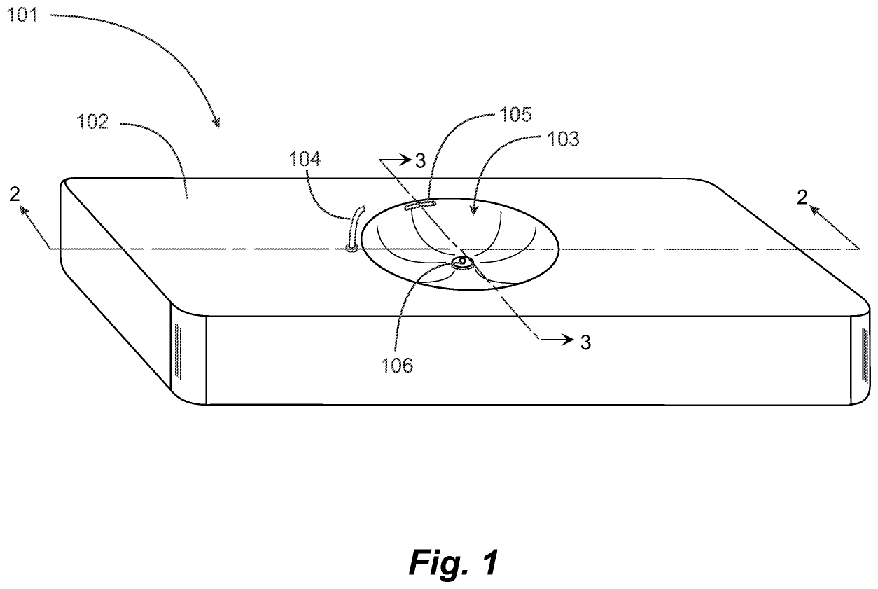

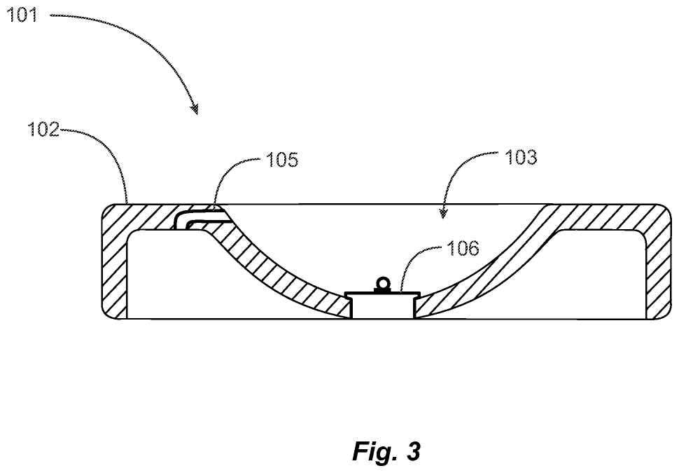

FIG. 1 is a perspective view of a pet drinking bowl integrated with a toilet tank lid as an apparatus 101 in one embodiment of the present invention. Apparatus 101 has a body 102 with length, width, depth and side walls as a conventional toilet tank lid. A bowl depression 103 is formed in a horizontal upper wall of the lid with a drain opening at center bottom of the bowl, in this view closed with a stopper 106. Stopper 106 may be of different sizes and different materials in different embodiments. The stopper may be removed to drain the bowl for cleaning, for example. In some embodiments there may be a tether, such as a chain, connected to the stopper and to another point on the lid or to a point on a wall outside the lid, An overflow opening 105 is implemented at an upper rim of bowl 103 to provide for water to be drained from the bowl to avoid overflow. The overflow opening passes through the top of body 102 so overflow flows into the toilet tank, and this connection is shown below with reference to FIG. 3 cross-section.

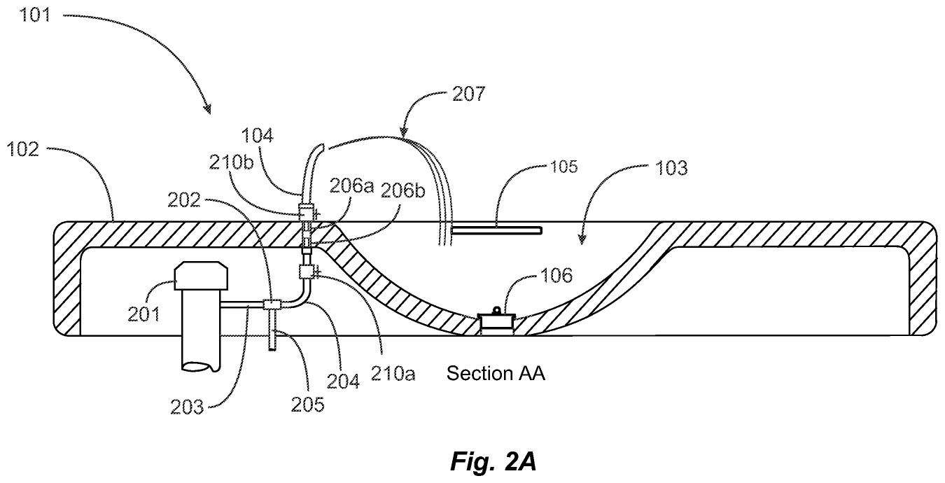

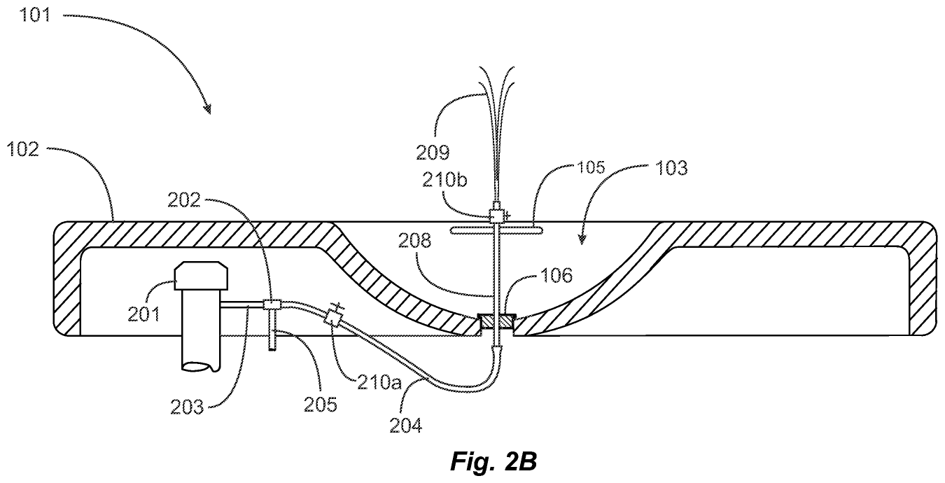

A spout projection 104 is implemented in another opening through body 102 and is connected below the body to a water supply tube in the tank fill apparatus. This connection and function is described below with reference to FIG. 2 cross-section.

In one embodiment of the invention water flows into bowl 103 through spout projection 104 with stopper 106 in place. If water flows into the bowl after the water level reaches overflow opening 105, excess water flows back into the toilet tank.

FIG. 2A is a cross section of apparatus 101 of FIG. 1 taken along the section line 2-2 of FIG. 1. In this lengthwise section bowl 103 in body 102 is shown with a central drain opening at the bottom of the bowl, closed with a conventional stopper 106. In other embodiments the drain opening may be of a smaller diameter, and the stopper may be implemented differently.

In FIG. 2A overflow opening 105 is seen at an uppermost location in the rear of the bowl. In other embodiments the overflow opening may be implemented at other locations around the circumference of the upper rim of bowl 103.

In FIG. 2A an opening is implemented upward through top of body 102 close to the rim of bowl 103, with inserts 206a and 206b on top of body 102 and underneath. Inserts 206a and 206b are formed for connecting flexible tubing or other conduits. In the embodiment shown in FIG. 2A tubing 203 proceeds from filler mechanism 201 in the toilet tank under apparatus 101. Filler mechanism 201 is a well-know mechanism in most toilet tanks, and a tube from the filler mechanism typically is placed into a fill tube that supplies water from the fill mechanism directly to the main toilet bowl. In this embodiment of the invention a tee 202 is used to branch off a second flexible tube 204 that is connected to insert 206a on the underside of body 102. Tube 205 continues to the standard fill that provides water to the main toilet bowl during a flush cycle.

In this example a spout 104 is connected to insert 206b. Spout 104 is shaped to provide a stream of water 207 into bowl 103 in an arc above the bowl during a flush cycle. This stream in this embodiment is maintained during the time that the toilet tank is filling. It is known in cay behavior that cats prefer water in a stream to drink. Most domestic cats, for example, will preferably drink from a flowing faucet. The implementation of stream 207 by spout 104 is to provide such a stream for a user's domestic cat. The inventor believes that a user's cat will quickly learn to react to the fact of the toilet flushing to gravitate to bowl 103 for a drink of water.

In one embodiment there may be a flow control valve 210a in flexible tube 204 to enable a user to adjust the flow of water to spout 104 so the effect of stream 207 may be closely controlled. Although not shown explicitly in FIG. 2A, flexible tube 204 may be implemented with additional length in perhaps a coil to enable the user to remove the tank lid to reach and adjust valve 210a.

Also, in one embodiment there may be another flow control valve 210b implemented above the lid just below spout 104 enabling the user to adjust the stream 207 from above. One or both of the valves 210a and 210b may be used.

In one embodiment spout 104 is made of a semi-rigid polymer or synthetic or natural rubber. In this implementation spout 104 may give if in contact with an object and avoid breaking. In another embodiment insert 206b may be implemented to provide an upward arc of water from the upper surface of body 102, such that the arc of water will terminate in bowl 103.

FIG. 2B illustrates a section having somewhat different features than that of FIG. 2A. In the example of FIG. 2B there is no opening at an edge of the rim of the bowl as shown in FIG. 2A, but flexible tubing 204 connects to a rigid tube 208 that is inserted through a hole upward through stopper 106. Rigid tube 208 extends upward in this example to above overflow opening 105. During a flush and fill cycle water is projected from tube 208 in a stream 209 that falls back into bowl 103 and provides a stream or a domestic cat to drink from.

In one embodiment there may be a flow control valve 210a in flexible tube 204 just as described above for FIG. 2A, and flexible tube may be longer and coiled for ease of access for a user to adjust flow by valve 210a. In another embodiment there may be a flow control valve 210b at a top of tube 208 for the same purpose of flow control for stream 209.

FIG. 3 is a cross section of apparatus 101 of FIG. 1 taken laterally across body 102 at the center of bowl 103. This section illustrates the nature of overflow opening 105 which efficiently flows excess water in bowl 103 back into the toilet tank under body 102. In the example of FIG. 2B stopper 106 will show the rigid vertical tube 208.

The skilled person will understand that the embodiments described in detail above are entirely exemplary and are not limiting to the scope of the invention. There are many alterations in the embodiments described which will still fall withing the scope of the invention. It was mentioned above, for example, that the overflow opening might be located at different positions around the upper rim of the bowl. In some embodiments there may be no fountain implementation, and water may be provided to bowl 103 during a flush and fill cycle though an opening in body 102 directly into bowl 103. Stoppers of various sorts may be used, and in at least one embodiment there may be no drain opening at the bottom of the bowl. Water in that case might be scooped from the bowl, or the lid may simply be picked up and tipped to empty water in the bowl back into the tank or into the toilet bowl. There are many such alterations that might be made, all withing the scope of the invention. The scope of the invention is limited only be the claims.

1. A pet drinking bowl system, comprising:
a toilet tank lid having sidewalls implemented to fit over a top rim of a toilet tank, and a horizontal top wall with a molded-in bowl;
an overflow opening implemented at an upper rim of the molded-in bowl, the overflow opening communicating with an overflow passage through the top wall, such that above a depth from a bottom of the bowl to the overflow opening, water flows from the bowl to the toilet tank; and
a fill passage through the top wall having first fitting under the top wall connecting the fill passage by a flexible tube to a fill mechanism in the toilet tank, and a fitting above the top wall connecting the fill passage to a spout shaped to provide a stream of water in an arc above the bowl into the bowl;
wherein, during a flush and fill cycle water from the fill mechanism is supplied to the spout, which provides water in a stream to the bowl, and excess water in the bowl drains back to the toilet tank through the overflow opening.

2. The pet drinking bowl system of claim 1 further comprising a drain opening at a lowermost extremity of the bowl, and a stopper sized to fit the drain opening, such that the drain opening may be plugged to hold water in the bowl or unplugged to drain water from the bowl.

3. The pet drinking bowl system of claim 2 wherein the stopper further comprises a tether connecting the stopper to a point away from the drain opening.

4. The pet drinking bowl system of claim 1 further comprising a first flow control valve implemented in the flexible tube from the fill mechanism, enabling a user to adjust flow of water through the flexible tube.

5. The pet drinking bowl system of claim 1 further comprising a second flow control valve implemented above the top wall below the spout enabling a user to adjust flow of water to the spout above the lid.

6. A pet drinking bowl system, comprising:
a toilet tank lid having sidewalls implemented to fit over a top rim of a toilet tank, and a horizontal top wall with a molded-in bowl;
an overflow opening implemented at an upper rim of the molded-in bowl, the overflow opening communicating with an overflow passage through the top wall, such that above a depth from a bottom of the bowl to the overflow opening, water flows from the bowl to the toilet tank;
a drain opening at a lowermost extremity of the bowl, and a stopper sized to fit the drain opening, such that the drain opening may be plugged to hold water in the bowl or unplugged to drain water from the bowl; and
a rigid tube passing upward through a hole in the stopper, with the stopper in place plugging the drain opening, extending to a height above the rim of the bowl, the rigid tube connected below the bowl to a flexible tube to a fill mechanism in the toilet tank;
wherein, during a flush and fill cycle water from the fill mechanism is supplied to the rigid tube, which provides water in a stream to the bowl, and excess water in the bowl drains back to the toilet tank through the overflow opening.

7. The pet drinking bowl system of claim 6 further comprising a first flow control valve implemented in the flexible tube from the fill mechanism, enabling a user to adjust flow of water through the flexible tube.

8. The pet drinking bowl system of claim 6 further comprising a second flow control valve implemented in the rigid tube at an uppermost end, enabling a user to adjust flow of water in the stream to the bowl.

9. The pet drinking bowl system of claim 1 wherein the spout is implemented in a flexible material such that the spout deforms rather than breaks.

10. The pet drinking bowl system of claim 1 wherein the flexible tube connecting to the fill mechanism has a tee with a tube from an outlet of the tee providing water to the toilet bowl during a flush and fill cycle.

11. The pet drinking bowl system of claim 6 wherein the flexible tube connecting to the fill mechanism has a tee with a tube from an outlet of the tee providing water to the toilet bowl during a flush and fill cycle.
